(19) United States
(12) Patent Application Publication
(10) Pub. No.: US 2008/0023233 A1
(43) Pub. Date: Jan. 31, 2008

(54) Drive Unit For Trailers And Caravans

(75) Inventor: Knud Erik Westergaard, Hadsund (DK)

Correspondence Address: WILLIAM J. SAPONE;COLEMAN SUDOL SAPONE P.C., 714 COLORADO AVENUE, BRIDGE PORT, CT, 06605, US

(73) Assignee: Sunmover ApS, Hadsund (DK)

(21) Appl. No.: 11/466,495

(22) Filed: Aug. 23, 2006

(30) Foreign Application Priority Data
Jul. 27, 2006 (DK) PA 2006 01017

(51) Int. Cl. B62D 55/00

(52) U.S. Cl. 180/9.1

(57) ABSTRACT

According to the invention, a drive unit for trailers or caravans is provided that has a chassis (2) with crawler sections (3), a coupling device (4) and steering and maneuvering devices. The drive unit is coupled to the trailer or caravan and is used to position the trailer or caravan in a controlled and simple manner, without having to worry about the risk of colliding with a neighbor or damaging one's own vehicle.

### THE PRIOR ART

The invention relates to a motorized, maneuverable drive unit intended to be mounted on the nose wheel suspension of trailers and caravans in particular.

It is well-known that maneuvering with a trailer or a caravan frequently gives rise to problems when the trailer or the caravan is moved the last distance to or from the location where it is to be parked or has been used.

The car is frequently disconnected before the trailer or the caravan is completely in place, a matter which may be explained by the fact that the drivers are not experienced in performing the necessary maneuvers in the restricted space at the location, and that he is afraid of damaging his own or the neighbor's caravan. If, at the same time, the support is soft or irregular, the weight of the trailer or of the caravan and the size of the obstacles are often beyond the powers of the drivers to maneuver them into place, resulting in quarrels among the participants.

For years, many attempts have been made at solving this well-known problem, and it has been found that the problem is so great that people are ready to spend even a great sum of money on a useful solution.

The known solutions to the above-mentioned problem may be divided into two main groups, viz. a group of manually operated drive units and a group of motorized units, where the manually operated group may additionally be divided into solutions determined by whether the drive unit is mounted on the normal coupling or on the nose wheel, and where the motorized group may additionally be divided into solutions determined by whether the drive unit is mounted on the main wheel of the trailer or on the nose wheel.

The group of manually operated units includes examples of solutions where a hand crank and a chain drive are used, which may be operated by one person and be coupled to the trailer via the normal coupling, see e.g. the product Avinex on the homepage www.berlynenterprises.com.

Another manual solution is shown in the patent US 2003/0042707, where the drive unit is pivotally mounted on the hitch of the trailer and may be operated with a hand crank, which is in engagement with a nose wheel via a gear.

The published applications GB 2392890 and WO 2004/037567 disclose examples of solutions with hand cranks, and where the drive unit is integrated in the nose wheel suspension, and the tractive force is transferred via the nose wheel. In the group of motorized solutions, it will be seen in the patent specification GB 2316922 how a friction roller, driven by an electric motor, is arranged in engagement with the main wheel of the trailer or of the caravan, and that the drives may be operated via a wireless unit.

Other motorized solutions are disclosed in the documents U.S. Pat. No. 6,991,050, U.S. Pat. No. 25 6,945,343, U.S. Pat. No. 4,860,841 and GB 2419575. Here, the drive unit is disposed in connection with the nose wheel in specially adapted nose wheel suspensions.

It has been found that, in many cases, the manual solutions do not meet the expectations which the users have in respect of the products. For one thing, it is difficult to control and apply sufficient forces to the hand crank at the same time, and, for another, it is difficult to make the nose wheel transfer the forces so the support without the wheel slipping on the support. Attempts at increasing the weight of the nose wheel have not been found effective, and have just meant that even greater forces have to be transferred via the hand crank and the nose wheel.

Among the motorized solutions, the solution where a drive motor with a friction roller is arranged at each of the main wheels, is the best and the most efficient one.

However, the solution is technically complicated and rather expensive and must therefore be mounted at the garage of a trailer dealer. The system is based on battery-driven electric motors, which consume much power, and the batteries are therefore rapidly depleted. Usually, it is necessary to have extra battery capacity and charging equipment to maintain a sufficient charge of the batteries, so that the batteries may be charged by connection to the mains at the camping site or at home.

The solutions where the drive units are mounted in connection with the nose wheel and its suspension are considerably less expensive and can generally be mounted by the user himself. These solutions, however, are vitiated by the same problem as the manual ones, because the contact face and thereby the friction between the nose wheel and the support is too small for the traction to be transferred to the trailer, in particular if the trailer has been standing on a soft base. It has also been found that the available motor power and battery capacity are too small in several cases.

### THE OBJECT OF THE INVENTION

The object of the invention is to overcome these drawbacks, and this is achieved by constructing a motorized, maneuverable drive unit so that it comprises a chassis with at least one crawler section mounted on the chassis, a coupling device to be coupled together with the nose wheel suspension, as well as means for steering and maneuvering the drive unit.

The crawler sections provide a large surface contact and thereby great friction between the drive unit and the support, so that it is possible to transfer great tractive forces to the trailer or the caravan. Further, the crawler sections give good maneuvering options in cooperation with the steering and maneuvering means. The coupling-together with the nose wheel suspension results in a very simple and inexpensive assembly, as the existing nose wheel is merely replaced by the drive unit.

When a crawler section is further mounted on each side of the chassis, a significant increase of the contact face between the drive unit and the support is achieved, while providing a drive unit which is easy to maneuver, as the sections may be coupled together and pull the same way or pull their separate ways, e.g. in connection with a turn.

When each of the crawler sections is further configured so that they comprise a motor with a gear which is in engagement with a driving wheel, an idling wheel, at least one support wheel and a crawler belt via a drive connection in the form of a chain wheel drive or a drive belt connection, an effective drive system is achieved, consisting of simple and inexpensive standard components which are easy to acquire or produce.

When the driving wheel is further provided with a spring-loaded coupling constructed to lock the drive shaft with the drive wheel by a set of coupling means, which may be displaced axially, and where the coupling may be released manually, it is ensured that the drive unit may be used as a normal nose wheel in case of a missing energy supply.

When the motor is further equipped with a gear which reduces the number of revolutions of the output shaft of the gear by a factor of 10 to 100, and a drive connection which reduces the number of revolutions of the shaft of the drive wheel by a factor of 1.20 to 5, it is ensured that a sufficient power transfer to the crawler belt may be established in very limited space.

When the outer side of the crawler belt is further provided with a strong friction-generating pattern, a large contact area between the belt and the support with a very great friction is achieved.

When the coupling device is further configured so as to comprise a reversed U-profile secured to the top of the chassis, said U-profile being equipped with a bore for receiving a bolt, as well as a lockable steel bolt for coupling the drive unit and the nose wheel suspension together, it is ensured that the drive unit and the trailer or the caravan may be coupled together in a simple and inexpensive manner, without having to make radical changes of the existing structure, so that the mounting may be carried out by other than skilled persons.

When the drive unit is further provided with means for directional steering, it is ensured that it is possible to steer and maneuver the trailer.

When the steering and maneuvering means are further constructed as a steering grip with control facilities for manual control, or as a remote control unit which allows wireless as well as non-wireless control via a motor control system, it is ensured that the drive unit may be operated in several ways, thereby making it possible to apply both methods depending on the situation concerned.

Finally, it is expedient to further construct the chassis with an enclosure for the storage of a battery pack as well as the stated electrical circuit modules. Moreover, it is expedient to mount a solar cell module on the top of the chassis and to mount a charging plug on the end plate of the chassis, and it is likewise expedient to adapt the electronic circuits to be able to cooperate with each other, and to base the wireless signals on coded infrared light or coded signals in the radio frequency range, and to provide the motor control circuit with a soft start function.

### BRIEF DESCRIPTION OF THE DRAWINGS

Preferred exemplary embodiments will be described more fully below with reference to the drawing, in which

FIG. 1 shows a perspective view of the drive unit according to the invention,

FIG. 2 shows a perspective view of a section through the drive unit,

FIG. 3 shows a perspective view of the drive unit with applied steering grip, and

FIG. 4 shows a perspective view of a remote control unit.

### DESCRIPTION OF EXEMPLARY EMBODIMENTS

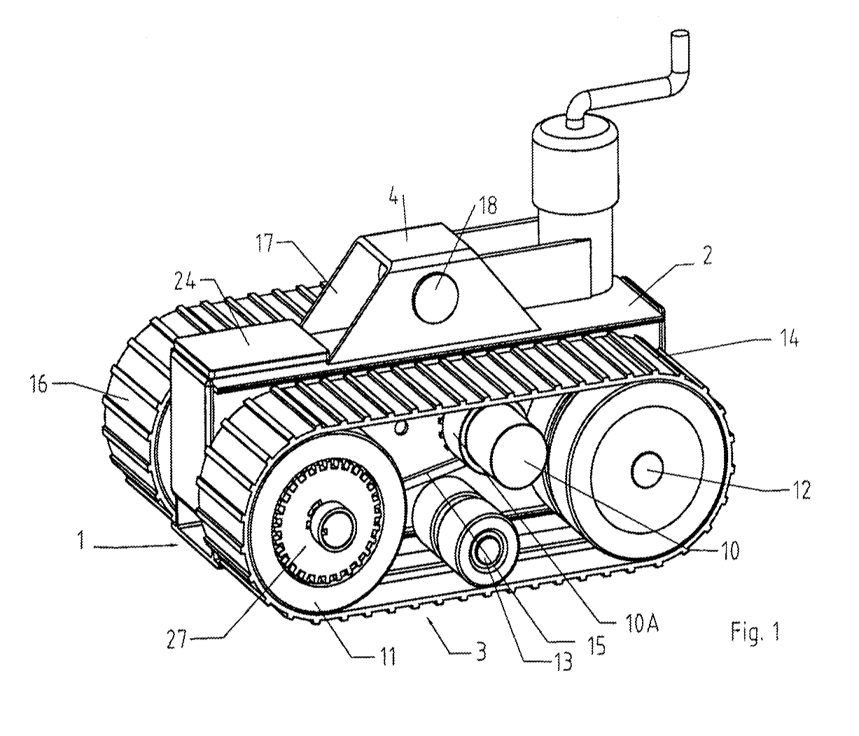

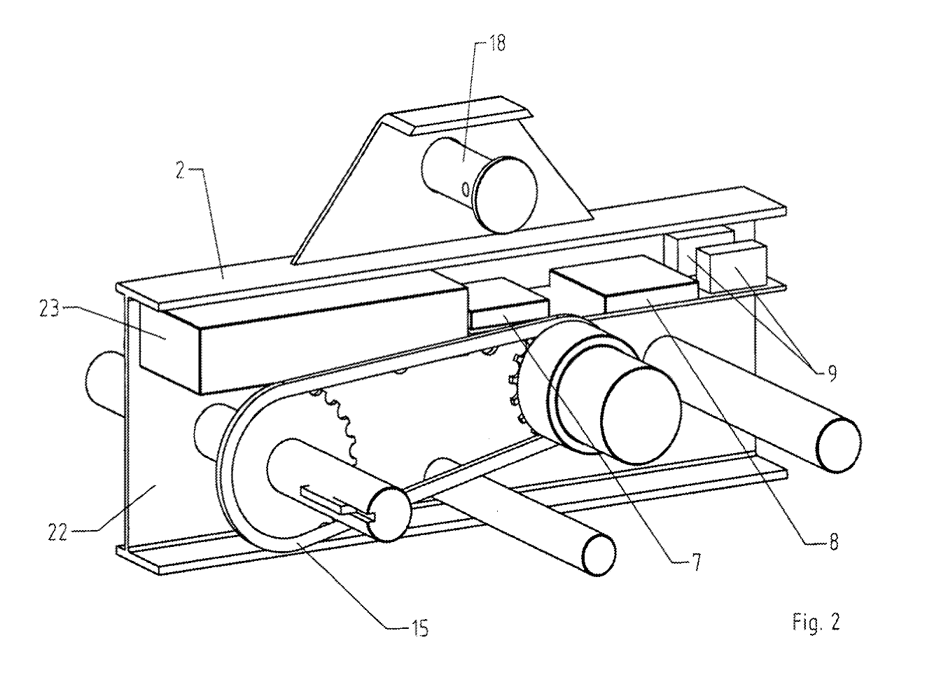

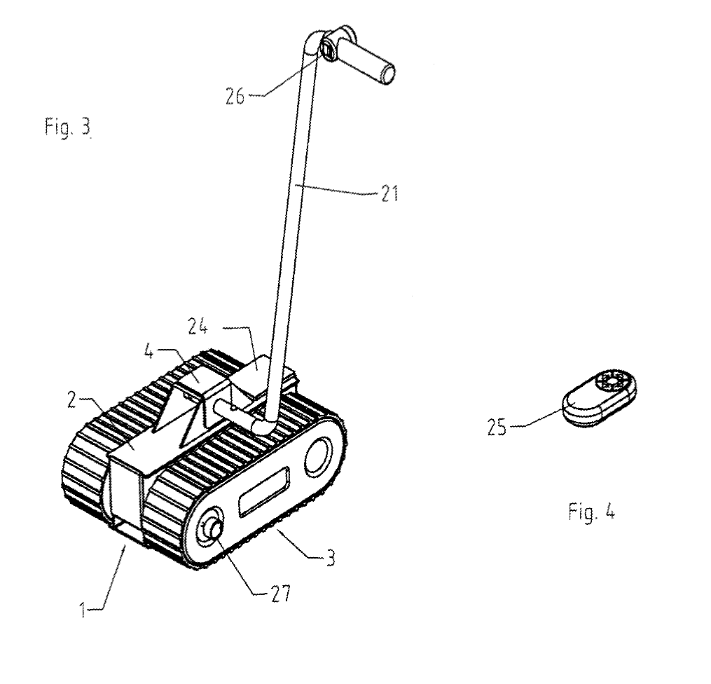

Exemplary embodiments shown in FIG. 1, FIG. 2, FIG. 3 and FIG. 4, respectively, will be described below.

FIG. 1 shows how the drive unit 1 is constructed, and the main components which are included. The drive unit 1 is based on a chassis 2 made of a profile on which crawler sections 3, a coupling device 4 for coupling to the nose wheel suspension of the trailer or of the caravan, as well as means for steering and maneuvering the drive unit may be mounted. The profile is dimensioned to be capable of supporting the load which is normally applied to the nose wheel. The profile may be extruded, but may also be welded. The material may be aluminum or steel.

The crawler sections 3 are mounted on each side of the chassis 2, as will be seen. The crawler sections 3 comprise a motor 10 with a gear 10a which is in engagement with a driving wheel 11, an idling wheel 12, at least one support wheel 12 and a crawler belt 14 via a drive connection 15. The drive connection may be established according to known principles and with known components, where chain wheel and chain is one of the solutions, but it may also be established as a toothed belt connection or a V-belt connection. A preferred embodiment is a chain wheel drive. The drive connection is dimensioned to reduce the number of revolutions by a factor in the range from 1.20 to 5.

The driving wheel 11 is provided with a spring-loaded coupling configured to lock the drive shaft with the drive wheel by a set of coupling means, which may be displaced in an axial direction, and which may be released manually by a grip 27, so that the belt may move freely and serve as a traditional nose wheel, if the energy supply should fail.

The motor 10 is an electric motor with a gear 10a mounted thereon. The motor operates on DC current and is fed from a DC voltage source. The gear 10a, which is constructed to cooperate with the motor 10, is dimensioned to reduce the number of revolutions by a factor in the range from 10 to 100. The gear is of a known structure and may be of a type having an offset or angled input shaft and output shaft, or a type where the input shaft and the output shaft are positioned in extension of each other.

The crawler belt 14 is made of a flexible material, such as plastics or rubber. The outer side of the belt is equipped with a pattern 16 which is configured so as to provide great friction between belt and support, whereby slipping is reduced to the greatest extent possible. The belt 14 runs around the wheels 11, 12, and 13, at least one support wheel 13 ensuring that the traction forces are transferred to the support to the greatest extent possible by pressing the belt between the wheels 11 and 12 tightly against the support so that the contact face against the support is as great as possible.

A coupling device 4 is arranged on the top of the chassis 2, said coupling device being intended to couple the drive unit 1 together with the nose wheel suspension of the trailer or of the caravan. The coupling device is configured as a U-profile 17 which is secured to the upper side of the chassis. The U-profile is provided with a bore for receiving a bolt 18, which bolt may be passed through the bore on the wheel fork of the nose wheel suspension and the bore in the U-profile of the drive unit in order to couple the drive unit and the nose wheel suspension together. The coupling-together is performed after the nose wheel has been removed. The use of the nose wheel suspension for the coupling-together ensures that the mounting of the drive unit may be performed in a simple manner by unskilled persons. The bolt 18 is configured so that it may be locked after mounting, to thereby ensure that the drive unit can remain mounted as long as the user so wishes.

The drive unit is provided with means for directional steering. FIG. 3 shows an embodiment with a steering grip 21 for manual steering, which is mounted on the drive unit at the coupling device 4 by means of the bolt 18. The steering grip incorporates a remote control unit 26 for the control of the speed of the motor drive and the direction of rotation via the motor control system. FIG. 4 shows another embodiment of a remote control unit 25. Both control units (25, 26) are adapted for wireless communication, and they are for electrical control of the drive unit via a motor control system, which can control all functions in connection with start and stop, speed, forward, reverse as well as turning to the right or to the left. The control units are also available in a non-wireless embodiment.

The chassis 2 is additionally adapted to contain the control system and the energy supply for steering and maneuvering the drive unit. FIG. 2 shows a sectional view of the drive unit. It is shown that the chassis is provided with an enclosure 22 in which the battery pack 23, a charging circuit 7 for the battery, an electrical motor control circuit 8 and a communications circuit 9 are positioned. Further, a solar cell module 24 (see FIG. 1), which is the energy supply for the charging circuit 7, is arranged on the top of the chassis, and a power plug (not shown) for the connection of an external charging unit to the battery pack is mounted on the end plate of the chassis.

The battery pack 23 consists of a plurality of rechargeable batteries having a great capacity. Lithium batteries are a preferred type. The charging circuit 7 is dimensioned to cooperate with the battery pack 23 and the solar cell module 24. The motor control circuit 8 is arranged with soft start and to be able to control at least two motors individually and to cooperate with the communications circuit 9, which is adapted to cooperate with the control units 25 and 26 and to communicate in a non-wireless or a wireless form, and the wireless form is based on coded infrared light or coded radio signals, so that wireless signals from foreign control units cannot activate the drive unit.

1. A motorized, maneuverable drive unit (1) intended to be mounted on the nose wheel suspension of trailers and caravans in particular, characterized in that the drive unit (1) comprises a chassis (2) with at least one crawler section (3), a coupling device (4) to be coupled together with the nose wheel suspension, as well as means for steering and maneuvering the drive unit.

2. A drive unit according to claim 1, characterized in that a crawler section (3) is mounted on each side of the chassis (2).

3. A drive unit according to claim 1, characterized in that each of the crawler sections (3) comprises a motor (10) with a gear (10a) which is in engagement with a driving wheel (11), an idling wheel (12), at least one support wheel (13) and a crawler belt (14) via a drive connection (15) in the form of a chain wheel drive or a drive belt connection.

4. A drive unit according to claim 3, characterized in that the driving wheel (11) is provided with a spring-loaded coupling for locking the drive shaft together with the drive wheel by a set of axially displaceable coupling means, which are released by a manual grip (27).

5. A drive unit according to claim 3, characterized in that the gear (10a) reduces the number of revolutions by a factor of 10 to 100 times, and that the drive connection reduces the number of revolutions by a factor of 1.20 to 5 times.

6. A drive unit according to claim 3, characterized in that the outer side of the crawler belt (14) is provided with a strong, friction-generating pattern (16).

7. A drive unit according to claim 1, characterized in that the coupling device (4) comprises a reversed U-profile (17) secured to the top of the chassis (2), said U-profile being equipped with a bore for receiving a bolt, as well as a lockable steel bolt (18) for coupling the drive unit and the nose wheel suspension together.

8. A drive unit according to claim 1 characterized in that the drive unit is provided with means for directional steering.

9. A drive unit according to claim 8, characterized in that the means for directional steering are manual in the form of a steering grip (21).

10. A drive unit according to claim 8, characterized in that the means for directional steering are electrical and comprise a motor control system (8, 9).

11. A drive unit according to claim 10, characterized in that the control means comprise a wireless and/or a non-wireless connection between the motor control system (8, 9) and a remote control unit (25, 26).

12. A drive unit according to claim 1, characterized in that the chassis (2) additionally comprises an enclosure (22) for a battery pack (23), a charging circuit (7) for the battery, an electrical motor control circuit (8) as well as an electrical communications circuit (9) for remote control of the drive unit, that a solar cell module (24) is additionally arranged on the top plate of the chassis, the charging circuit (7) adapted to cooperate with the battery pack (23) and with the solar cell module (24), the end plate of the chassis provided with a charging plug for an external charging unit, the motor control circuit (8) provided with a soft start function and adapted to control at least two motors individually and to cooperate with the communications circuit (9), and the communications circuit adapted to operate with non-wireless signals or with wireless signals based on coded, infrared light or coded signals in the radio frequency range.

13. A drive unit according to claim 2, characterized in that each of the crawler sections (3) comprises a motor (10) with a gear (10a) which is in engagement with a driving wheel (11), an idling wheel (12), at least one support wheel (13) and a crawler belt (14) via a drive connection (15) in the form of a chain wheel drive or a drive belt connection.

14. A drive unit according to claim 13, characterized in that the driving wheel (11) is provided with a spring-loaded coupling for locking the drive shaft together with the drive wheel by a set of axially displaceable coupling means, which are released by a manual grip (27).

15. A drive unit according to claim 13, characterized in that the gear (10a) reduces the number of revolutions by a factor of 10 to 100 times, and that the drive connection reduces the number of revolutions by a factor of 1.20 to 5 times.

16. A drive unit according to claim 13, characterized in that the outer side of the crawler belt (14) is provided with a strong, friction-generating pattern (16).
